(19) United States
(12) Patent Application Publication
(10) Pub. No.: US 2020/0275621 A1
(43) Pub. Date: Sep. 3, 2020

(54) AUTONOMOUS PLANT GROWING SYSTEM

(71) Applicant: EROLL GROW-TECH LTD., Yokne'am Illit (IL)

(72) Inventors: Michael MAMAN, Haifa (IL); Zohar LEVY, Kiryat Bialik (IL); Uri ZEEVI, Givatayim (IL)

(73) Assignee: EROLL GROW-TECH LTD., Yokne'am Illit (IL)

(21) Appl. No.: 16/062,611

(22) PCT Filed: Dec. 12, 2016
(86) PCT No.: PCT/IL2016/051327

§ 371 Date: Jun. 14, 2018

(30) Foreign Application Priority Data
Dec. 17, 2015 (IL) 243172

(51) Int. Cl. A01G 31/02; A01G 7/04; A01C 23/00; G05B 19/042

(52) U.S. Cl. CPC A01G 31/02; A01G 7/045; G05B 2219/25011; G05B 19/042; G05B 2219/2625; A01C 23/007

(57) ABSTRACT

An autonomous plant growing system, comprising: a) a body having an interior volume defined by a front portion, two side panels, a top panel, a bottom panel, and a back panel; b) at least one adjustable lighting assembly for enabling to automatically adjust the lighting condition within the interior volume, in order to provide optimal lighting conditions with respect to each growing state of the plant; c) an irrigation assembly that function as an aeroponic assembly and a hydroponic assembly; d) one or more sensors for obtaining data that represents the condition of the plant and the growing environment within the interior volume; and e) a control unit configured to automatically control the adjustable lighting assembly and the irrigation assembly and to self-perform respective growing process operations during the growing states of the plant.

### CROSS-REFERENCE TO RELATED APPLICATIONS

This application is a U.S. National Stage of International Patent Application No. PCT/IL2016/051327 filed on Dec. 12, 2016, designating the United States and claiming benefit of Israeli Application No. 243172 filed on Dec. 17, 2015.

### FIELD OF THE INVENTION

The present invention relates to the field of indoor plant(s) growing systems. More particularly, the invention relates to an autonomous plant growing system that enables to grow plants in an automatic manner, and it may further combine aeroponic and hydroponic growing process.

### BACKGROUND OF THE INVENTION

Home based agriculture is growing in popularity. A plant growing system should create an artificial environment for indoor plant cultivation by avoiding all interference of external climatic factors, to realize an accurate simulation of the cultivating environment, the production of high quality plants, good yield, with incomparable advantage of cultivation pattern.

It is an object of the present invention to provide a system which is capable of applying an intelligent environment simulation for plant growth and development that involve optimal lighting conditions and irrigation with respect to the growing state of the plant.

It is another object of the present invention to provide a system which is capable of enabling to grow relatively tall plants in a closed unit with limited space in terms of inner volume and height. Other objects and advantages of the invention will become apparent as the description proceeds.

### SUMMARY OF THE INVENTION

The present invention relates to a plant growing unit for enabling to grow plants in an automatic manner, comprising: a) a body having an interior volume defined by a front portion, two side panels, a top panel, a bottom panel, and a back panel; b) at least one adjustable lighting assembly for enabling to automatically adjust the lighting condition within the interior volume, in order to provide optimal lighting conditions with respect to each growing state of the plant; c) an irrigation assembly that function as an aeroponic assembly and a hydroponic assembly; d) one or more sensors for obtaining data that represents the condition of the plant and the growing environment within the interior volume; and e) a control unit configured to automatically control the adjustable lighting assembly and the irrigation assembly and to self-perform respective growing process operations during the growing states of the plant.

According to an embodiment of the invention, the unit further comprises an air condition and circulation system for enabling to control the temperature and humidity within the interior volume.

According to an embodiment of the invention, the unit further comprises at least one camera for providing visual data of the plant, thereby enabling to inspect the health condition of the plant and to monitor the growing process.

According to an embodiment of the invention, the control unit is electrically connected to the adjustable lighting assembly, the irrigation assembly and the sensors through respective power lines and/or through respective wireless signals.

According to an embodiment of the invention, the wireless signals are provided via Near Field Communication (NFC) protocol or other protocols.

According to an embodiment of the invention, the control unit is configured to communicate with an external computer device, in particular a mobile device, via a wireless or wired communication means

According to an embodiment of the invention, the unit further comprises at least one nutrition supply source, in particular in form of a solution that includes one or more minerals that the plant needs.

According to an embodiment of the invention, the control unit is configured to automatically control a fertilization process and to balance pH of the solution.

### BRIEF DESCRIPTION OF THE DRAWINGS

In the drawings:

FIG. 1A schematically illustrates a top perspective view of a plant growing unit, according to an embodiment of the invention;

FIG. 1B schematically illustrates a bottom perspective view of the plant growing unit;

FIG. 1C schematically illustrates a rear view of the plant growing unit;

FIG. 1D schematically illustrates a front view of the plant growing unit;

FIG. 1E schematically illustrates a cross-section view of the plant growing unit along the line A-A as shown in FIG. 1D;

FIG. 2 schematically illustrates an adjustable lighting assembly of the plant growing unit, according to an embodiment of the invention;

FIGS. 3A-3C schematically illustrates different possible positions of the adjustable lighting assembly;

FIG. 4 schematically illustrates a possible implementation of the irrigation assembly located at the bottom portion of the plant growing unit, according to an embodiment of the invention; and

FIG. 5 schematically illustrates an autonomous plant growing system, according to an embodiment of the present invention.

### DETAILED DESCRIPTION OF THE INVENTION

Throughout this description the term “reservoir” is used to indicate a container adapted to hold liquid/solution. This term does not imply any particular shape, construction material or geometry, and invention is applicable to all suitable containers.

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components.

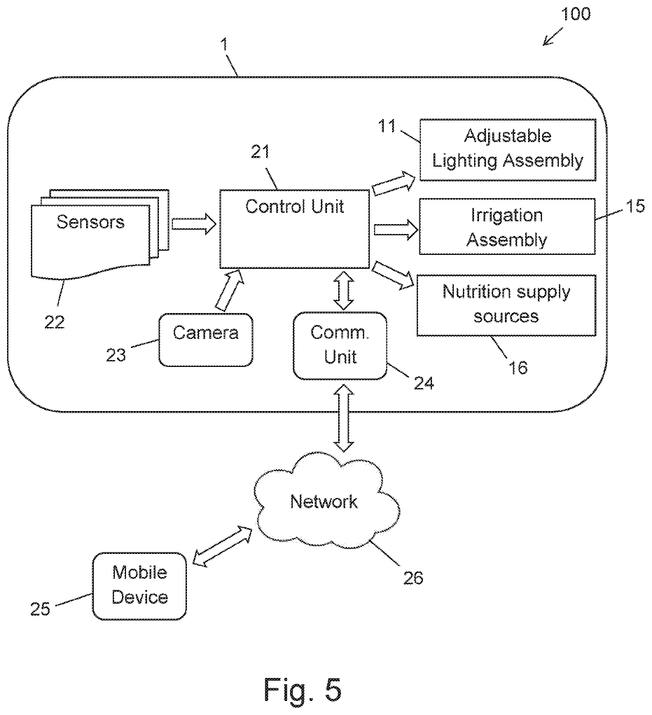

FIG. 5 schematically illustrates an autonomous plant growing system 100, according to an embodiment of the present invention. System 100 comprises a growing unit 1 that includes at least one adjustable lighting assembly 11, an irrigation assembly 15, one or more nutrition supply sources 16, a control unit 21, one or more sensors 22, at least one camera 23 and a communication unit 24. Growing unit 1 may communicate with external computer devices such as a mobile device 25 via a data network 26 (such as the Internet) which allows them to exchange data.

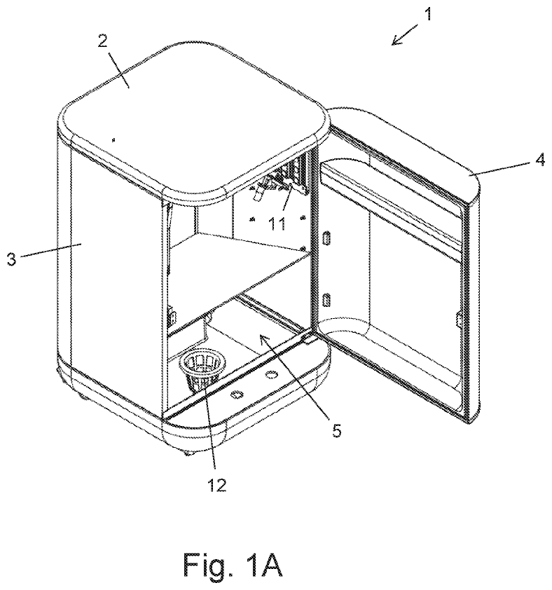

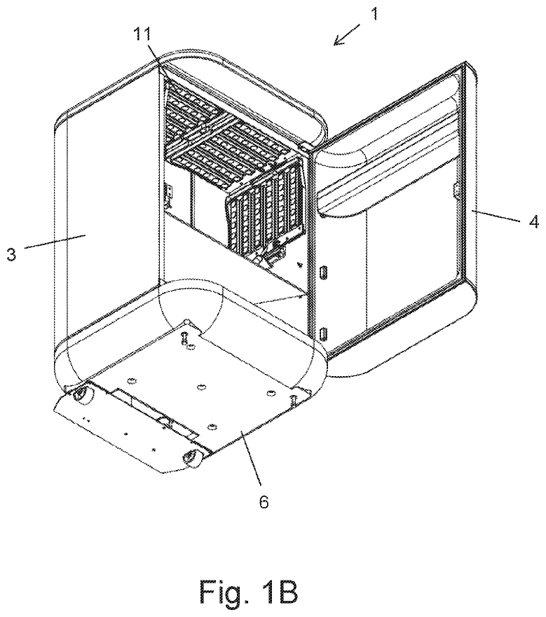

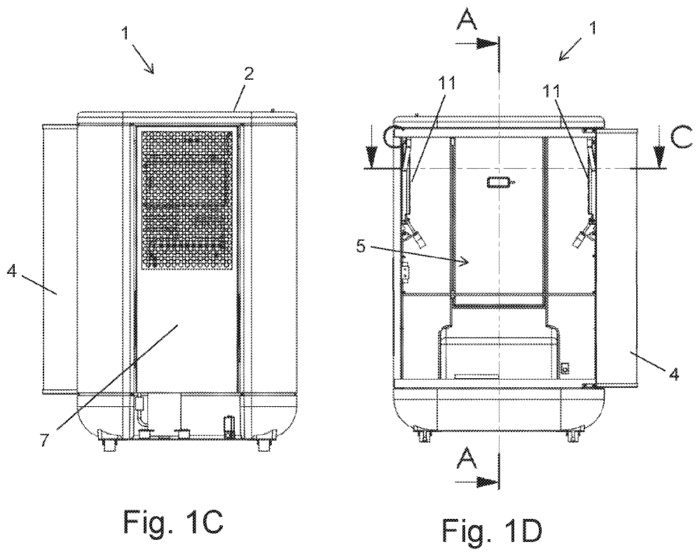

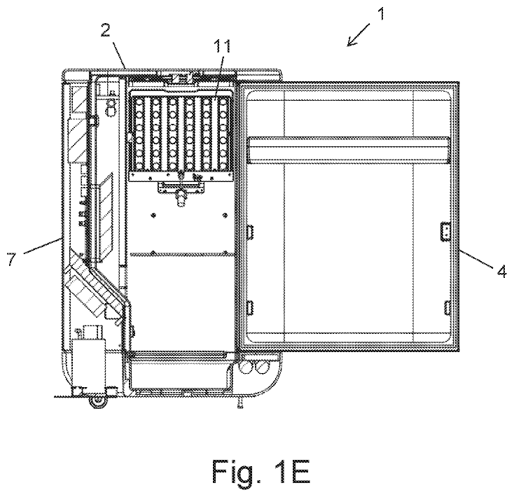

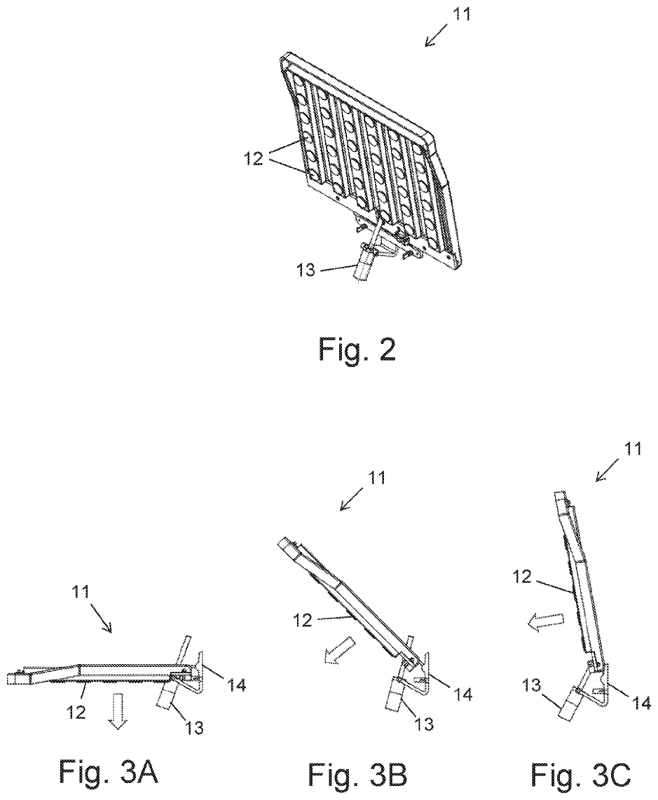

FIGS. 1A-1E show a structure of a growing unit 1 that can be used in conjunction with the invention. In this embodiment, the growing unit 1 has a body having an interior volume 5 defined by a front portion 4 (that also used as a door of the unit), two side panels 3, a top panel 2, a bottom panel 6, and a back panel 7. As show in these figures, the body of the growing unit 1 may have a form of a closet or a refrigerator.

The irrigation assembly 15 may function as a combination of an aeroponic assembly and a hydroponic assembly. The one or more sensors 22 (such as pH, CO₂, humidity, temperature, etc.) can be used for obtaining data that represents the condition of the plant during the growing process and of the growing environment within the interior volume of growing unit 1. The control unit 21 configured to automatically control the adjustable lighting assembly 11 and the irrigation assembly 15 and to self-perform respective growing process operations such as supplying nutrition in specific timing and quantity. Controlling the irrigation, the fertilization and the lighting condition results in an autonomous plant growing system that enables to effectively grow plants by are tall by nature, in a closed unit with limited space in terms of inner volume and height.

According to an embodiment of the invention, growing unit 1 is configured to be used also as an automatic fertilization system. In such configuration, the growing unit 1 comprises at least one nutrition supply source 16 (e.g., in form of a solution that is stored in a suitable reservoir such as a bottle) that may include one or more minerals that the plant needs, Electric Conductivity (EC) and pH sensors for enabling to control the minerals in the solution. Thereby enabling the plant to automatically consume what it needs during the growing process.

The control unit 21 is electrically connected to the adjustable lighting assembly 11, the irrigation assembly 15, the nutrition supply sources 16 and the sensors 22 through respective power lines and/or through respective wireless signals such as Near Field Communication (NFC) or other wireless protocols that enable to establish radio communication.

The adjustable lighting assembly 11 includes one or more light sources 12 (e.g., LED), so that a plant (e.g., planted in a pot) within growing unit 1 is irradiated with lights emitted from the light sources 12. The adjustable lighting assembly 11 enables the control unit 21 to automatically adjust the height and irradiation angle of the light sources 12 according to the growing state and stage of the plant. In addition, the control unit 21 may also control the illumination intensity of lighting assembly 11. FIGS. 3A, 3B and 3C show examples for different possible positions of the adjustable lighting assembly 11. For example, at the initial stage of the growing process, the height of the plant is relatively low (e.g., few centimeters, such as 2-5 cm), so that the control unit may instruct the adjustable lighting assembly 11 to move toward (i.e., to become close as much as possible) to the plant (e.g., as show in FIG. 3A). As the plant continues to grow, the adjustable lighting assembly 11 may be elevated and the irradiation angle of the light sources 12 can be adjusted to optimally fit the height and/or the growing state of the plant as shown with respect to FIGS. 3B and 3C (the dotted arrow indicates the direction of the light).

It should be noted, that the light system adjusts itself, as the plant grows, since plants need to be in an appropriate distance (e.g., no farer than 50 cm) from LED light in order for the photosynthetic to be as efficient as possible. For example, lighting assembly 11 may move in order to effectively adjust the distance from the plant with respect to the height of the plant during the growing process. This arrangement obviates many disadvantages of existing plant growing systems, in particular with respect to the growing of tall plants in a limited space. In other words, LED lights for plants growing exist, but no one actually identified or referred to the distance problem, as suggested by the system of the present invention, which enables to obtain a complete control of the height of the plant. The growing unit 1 enables to control how tall the plants will grow with respect to the dimension of the interior volume of unit 1.

According to an embodiment of the invention, the adjustable lighting assembly 11 may include a wall mounted element 14 to mount the adjustable lighting assembly 11 to an inner surface of that define the growing compartment, such as to the inner surface of the side panel 3 or top panel 2. A deflection mechanism (e.g., a piston-like arrangement), such as indicated by numeral 13 can be used to adjust the position of the adjustable lighting assembly 11.

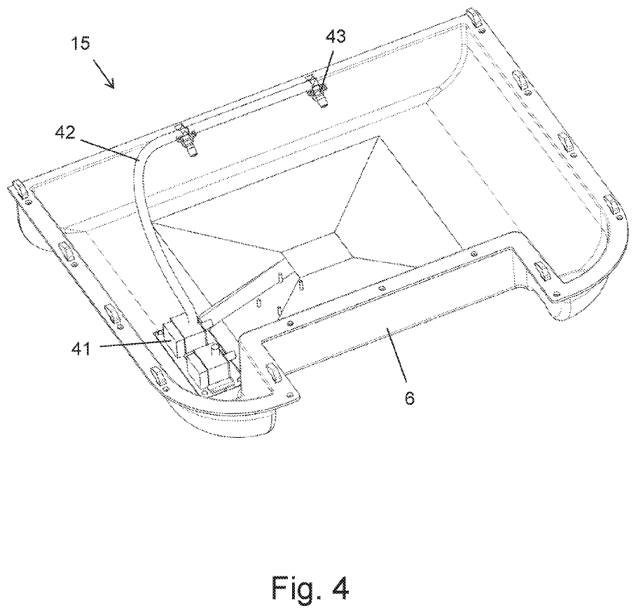

Referring now to FIG. 4, the irrigation assembly 15 may include at least one pump 41, distribution pipe(s) 42, one or more spray nozzles 43 and at least one fluid reservoir (not shown). In this embodiment and as shown in FIG. 4, some of the elements of irrigation assembly 15 are located at the inner portion of the bottom panel 6 of unit 1.

The irrigation may function as an aeroponic assembly and as hydroponic assembly through which, in both, water and nutrients from the one or more nutrition supply sources 16 (e.g., a reservoir in form of a bottle) are delivered to the fluid reservoir, and from there to the plant by the at least one pump 41 According to an embodiment of the invention, the growing unit 1 includes several reservoirs (i.e., nutrition supply sources 16) and each of them may include different content. For example, one reservoir may include water while another reservoir may include nutrition such as liquid fertilizers or other plant food. The irrigation assembly 15 supplies the required water and nutrition in a controlled manner (e.g., as instruct by the control unit 21). For example, the irrigation assembly 15 may work together with the nutrition supply sources 16 as a water-driven injection system that feeds advanced fertilizers and other products into the irrigation line (i.e., into the distribution pipes 42).

The following describes an example for a possible configuration for the growing unit 1. In this example, the fertilization and nutrition are placed in containers, from there they are delivered to a fluid reservoir (that can be located at the bottom section of the growing unit 1), from the fluid reservoir, two separate pumps 41 (in other configurations more than two pumps can be used) deliver the water with the nutrition & the minerals from the fluid reservoir to the plant root via pipes 42 and spray nozzle 43.

According to an embodiment of the invention, the plant is located a bit above the water, where its roots are about ⅓ immersed in the water and about ⅔ remain in the air. The pumps are located next to the roots and spray the water with the minerals. This is how the system of the present invention enables to combine simultaneously the aerophonic and hydroponic growing process.

With respect to the automatic fertilization system described hereinabove, the EC & PH sensors control the level of the mineral & the level of the PH and feed the plants (by spraying on the roots) automatically and exactly when the plants need.

In aeroponic assembly, the fluid reservoir may store liquid (e.g., water and nutrients) that are delivered to the spray nozzle by the pump. The pump can be mounted within the fluid reservoir in order to allow the pump to direct the flow of water and nutrients into the pipes. The spray nozzles enable the process of growing plants in mist environment. The fluid reservoir is in fluid communication with a distribution pipe through the pump. This allows the pump to direct water and nutrients from the fluid reservoir into the distribution pipe. Additionally, the distribution pipe is in fluid communication with the spray nozzle, allowing the water and nutrients to enter the at least one spray nozzle. The at least one spray nozzle is mounted within the growing unit 1 allowing the water and nutrients from the fluid reservoir to be distributed to the roots of the plant.

In the hydroponic assembly, the fluid reservoir may store liquid (e.g., water and nutrients) that are delivered to distribution pipes in order to ensure that about ⅓ of the roots remain in water. In some embodiment, the distribution pipes are configured to act as a drip irrigation system.

According to an embodiment of the invention, the growing unit 1 comprises air-conditioning (A/C) system that includes air circulation assembly for controlling the temperature and humidly within the interior volume of growing unit 1 (i.e., the growing compartment). The A/C system may work as a heating or cooling system, depending on the environmental temperatures (e.g., in cold days the A/C can be used to heat the interior volume of growing unit 1 and vice versa).

For medical consumption or other uses, there are types of plants that needed to be dried prior to the use (e.g., Cannabis). For such drying purpose, the growing unit 1 may include a drying system for enabling to apply a drying process for the plant. Depending on the type of plant, the drying process may involve the following setting the following conditions:
making the interior volume of growing unit 1 completely dark;
setting the temperature to the desired value (e.g., 23 Celsius degrees);
setting the humidity within the interior volume to the desired value (e.g., 65% humidity);
during the drying process (e.g., after few days) the humidity may be reduced (e.g., to 35%) until obtaining the desired drying level of the plant.

According to an embodiment of the invention, the system includes at least one camera installed within growing unit 1. The camera can be used as a sensor for evaluating and/or inspecting the condition of the plant (e.g., by applying suitable image processing algorithms to images captured by the camera). The camera(s) may have variety of uses, such as it can be used as an inspection tool to monitor the growing rate and the growing process of the plant within unit 1, to monitor plant health and as a tool to detect plant's dieses. For example, the inspection may involve measurements and analysis of the plant's parts such as the size of the leaves and the flowers at different stages of the growing process). Such inspections and monitoring may further be used to generate alerts or provide notifications to the user, in addition to the automatic control of the growing process (that may involve the supply of nutrition, minerals water, illumination, temperature, etc., in a controlled manner). Alternatively, or in addition, the camera can be used to enable live stream broadcasting of the plant, e.g., to be viewed through a mobile application or website adapted to communicate with the camera or with the control unit.

In some embodiments, the images captured by the camera can be sent to an external computer system (e.g., a server or a cloud computing) for enabling to remotely evaluate and/or inspect the condition of the plant.

A mobile device, such as a smartphone, or any other computer device can be used to communicate with the growing unit 1 via a data network (e.g., Internet) by using a dedicated mobile app or other software that is configured to interact with the growing unit 1. For example, the mobile can be used to remotely apply growing plans to the control unit, control the condition within the growing compartment, view live video streams of the plant, or perform any other possible tasks such as remotely unlocking and opening the door of the growing unit 1.

For example, the functions to control the plant growing unit as described herein may be performed by executable code and instructions stored in computer readable medium and running on one or more processor-based systems that can be part of the control unit as well as in a remote station. Those skilled in the art will appreciate that the invention may be practiced with different computer system configurations, including, multiprocessor systems, microprocessor-based or programmable consumer electronics, minicomputers, servers, cloud computing and the like.

As will be appreciated by the skilled person the arrangement described in the figures results in a system which is capable of applying an intelligent environment simulation for plant growth and development that involve optimal lighting conditions and irrigation with respect to the growing state of the plant.

All the above description and examples have been given for the purpose of illustration and are not intended to limit the invention in any way. Many different mechanisms, methods of analysis, electronic and logical elements can be employed, all without exceeding the scope of the invention.

1. A plant growing unit for enabling to grow plants in an automatic manner, comprising:
a) a body having an interior volume defined by a front portion, two side panels, a top panel, a bottom panel, and a back panel;
b) at least one adjustable lighting assembly that includes one or more light sources and a deflection mechanism for enabling to automatically adjust the lighting condition within the interior volume by automatically adjusting the height and irradiation angle of the light sources, in order to provide optimal lighting conditions with respect to each growing state of the plant;
c) an irrigation assembly that function as an aeroponic assembly and a hydroponic assembly;
d) one or more sensors for obtaining data that represents the condition of the plant and the growing environment within the interior volume; and
e) a control unit configured to automatically control the adjustable lighting assembly and the irrigation assembly and to self-perform respective growing process operations during the growing states of the plant.

2. A unit according to claim 1, further comprising an air condition and circulation system for enabling to control the temperature and humidity within the interior volume.

3. A unit according to claim 1, further comprising at least one camera adapted for providing visual data of the plant.

4. A unit according to claim 1, in which the control unit is electrically connected to the adjustable lighting assembly, the irrigation assembly and the sensors through respective power lines and/or through respective wireless signals.

5. A unit according to claim 1, in which wireless signals are provided via Near Field Communication (NFC) protocol or other protocols that enable electronic units to establish radio communication with each other.

6. A unit according to claim 1, in which the control unit is configured to communicate with an external computer device, in particular a mobile device, via a wireless or wired communication means.

7. A unit according to claim 1, further comprising at least one nutrition supply source, in particular in form of a solution that includes one or more minerals that the plant needs.

8. A unit according to claim 7, in which the control unit is configured to automatically control a fertilization process and to balance pH of the solution.

9. A unit according to claim 1, in which the control unit controls the illumination intensity of the lighting assembly.
